(19) United States
(12) Patent Application Publication
(10) Pub. No.: US 2007/0147357 A1
(43) Pub. Date: Jun. 28, 2007

(54) Method and apparatus for generating IP traffic in an internet protocol (IP) based network

(76) Inventors: Sylvain Pelletier, Laval (CA); Bruno Hivert, Longueuil (CA); Jean-Charles Beaudin, Montreal (CA)

Correspondence Address: Sandra Beauchesne;Ericsson Canada Inc., Patent Department, 8400 Decarie Blvd., Town Mount Royal, QC, H4P 2N2, CA

(21) Appl. No.: 11/316,932

(22) Filed: Dec. 27, 2005

(51) Int. Cl. H04L 12/66

(52) U.S. Cl. 370/356

(57) ABSTRACT

A method for having a computer-based node for simulating requests for Internet Protocol (IP) services for a group of IP terminal in an IP network. The method obtains at the computer-based node a test scenario from a memory, generates a computer medium based on the test scenario, reads computer readable medium stored at a persistent memory of the computer-based node, executes at the computer-based node instructions of the computer readable medium. The method further negotiates at the computer-based node a PPP connection for each IP terminal of the group of IP terminals and establishes at the computer-based node the PPP connection for each IP terminal of the group of IP terminals. Subsequently, the method sends from the computer-based node to a service switch a command for each IP terminal of the group of IP terminals and receives at the computer-based node responses from the service switch, wherein the responses include an indicator for indicating if a command is successful.

### BACKGROUND OF THE INVENTION

1. Field of the Invention

The invention relates to Internet Protocol (IP) simulations in a packet data network.

2. Description of the Related Art

With the convergence of wireline and wireless Internet industries operators and service providers benefit from the opportunity to base these networks on a common Internet Protocol (IP) network infrastructure 100 for service delivery to a terminal of an end-user 10 as shown in FIG. 1, which illustrates an IP based network in accordance to the prior art.

The IP network infrastructure 100 comprises, while not being limited to, an IP service management node 120 for supporting IP services like High Speed Internet Access, video on demand (Multicast), video broadcast (Multicast), Voice over IP (VoIP) and teleconferencing. The centralized IP management node 120 also interacts with service management systems 140 like virtual private networks (VPN), provides and manages access to IP based services in the network 100 or the Internet 150.

The IP service management node 120 manages access and IP networks to define, publish and control the delivery of IP services to end-users. More particularly, the purpose of the centralized IP service management system is to provide real time service control required for the delivery of advanced and dynamic IP services. The IP service management node 120 may provide basic access for services are subscribed to by consumers and enterprises to provide basic functionality. This typically includes broadband access connectivity from the customer premises to the service provider network, basic Internet access and is possibly bundled with an e-mail account and limited Web space. For most scenarios, an end-user hosts a computer or a mobile terminal that may be configured to use either Point-to-Point Protocol (PPP) or Dynamic Host Configuration Protocol (DHCP) for IP address allocation and session management. PPP may be itself directly mapped to an underlying circuit such as Asynchronous Transfer Mode (ATM) or conveyed via PPP over Ethernet (PPPOE) or Layer 2 Tunnelling Protocol (L2TP).

One of the key functions of the IP service management node 120 is to provide a bi-directional flow-through of service and policy provisioning data between a service switch 130, which routes packet data from and to the end-user 10 and a web server 135.

The service switch 130 is connected between the end-user 10 and the web server 135 and is defined as being a routing and control protocols required to maintain the IP network infrastructure 100 and session level topology information. This platform implements the basic mechanism needed by the IP service management node 120 to enforce to each session, the necessary control to activate Quality-of-Service (QoS) based policies, ensure service delivery and conduct ongoing accounting. The service switch 130 is not aware of any user or subscriber related data and will need the IP service management system 120 to establish a session based on configuration data representing the subscriber service profile.

The web server 135 is a computer that delivers web pages to the end-user 10. The web server 135 comprises an IP address and possibly a domain name. The web server 135 may provide a secure connection to the end-user 10 with known protocol such as Secure Sockets Layer (SSL).

The IP service management node 120 comprises a Policy Server 122 for providing a session level service control and a Workflow engine 124 for delivering service definition. The IP service management node 120 may play a critical role in the execution of this vision as it is instrumental in cost effectively delivering common, integrated services over the network 100.

The Policy server 122 defines or changes a user service level like bandwidth-on-demand functionality, IPtv, Rapidity on Demand or adjustable download data rate traffic depending on the IP based service and according to the user's service profile. The Policy server 122 further uses resource adapters to feed policies to the service switch 130 and the Workflow engine 124. A Graphical user interface (GUI) (not shown) is provided to the end-user 10 for allowing interaction of service selection.

The Policy server 122 translates a service into the service switch specific policies, which are then related to the service switch 130. The Policy server 122 further utilizes features of the service switch 130 such as routing, filtering, rate limiting, traffic shaping and multicast as “service building blocks” or service attributes to provide a wide range of services able to be defined by the Workflow engine 124. The capabilities of the service switch 130 are then effectively configured on a per session basis to activate the required service.

In the initial phases of an IP service, the Workflow engine 124 provides the ability for an operator or service provider to define and advertise a service to subscribers. When a service definition is done, from a subscriber perspective, it includes what the service or service bundle with consist of. For example, it could be a Movie on Demand service that combines content and a QoS on the transport. The combination of the Workflow engine 124 and Policy server 122 determine the service building blocks required to make up that service and translates those building blocks into node specific policies as described in the previous section.

Once as service has been defined, the Workflow engine 124 ensures that the service is advertised to subscribers who are then able to select the service as desired. This in turn, initiates the service activation activity conducted by the Policy server 122 as well as ongoing monitoring for charging, service level management and other customer care purposes.

The IP service management node 120 also provides enhanced services are a complementary extension to a basic access service, and are typically characterized by bundling value-added content or application such as gaming, Quality of Service (QoS) profiles like tiered rate-limit, and dynamic service selection and activation.

By using the IP service management node 120, operators and service providers define services by using different policies and grouping them together. This enables them to rapidly create and provision new services to large number of their subscribers over a variety of access technologies like Digital Subscriber Line (DSL), Cable, Ethernet, General Packet Radio Service (GPRS) network. The common IP network infrastructure 100 of FIG. 1 focuses on subscribers connected via broadband wire-line access services aggregated by the service switch 130.

The service switch 130 provides edge routing to end-users with MPLS, broadband aggregation and functionalities, which consists of two very tightly coupled portions: a service control and bearer (or transport).

Using a combination of the IP service management node 120, the web server 135 and the service switch 130 provide the ability to dynamically provision and control services within the common IP network infrastructure 100 to the end-user 10.

The following elements are not shown in FIG. 1, but are included in the network 100: administrative portals, co-ordination of service life cycle management, a Complementary Systems, an Administration, Authorization, and Authentication (AAA) node, a Directory, a Domain Name Server (DNS) which consists of a building blocks for session level control, a Customer Care & Billing (CC&B), Network Management Systems (NMS)—building blocks in life cycle management, a Management of Subscriber profiles including levels of authorization and service level agreement, Service provider profiles, Network provisioning, Management of logical and physical network resources and Billing mediation, charging and billing functions.

In order to evaluate the efficiency and performance of the common IP network infrastructure 100 and in particular the IP service management node 120, it could be interesting to be able to perform a variety of test scenarios in the IP network 100. As of today, few solutions exist for testing the efficiency of the centralized IP service management system 120, the web server 135, the service witch 130 and ultimately the IP network 100. However, these solutions are not able to provide scalable test result as regards to the efficiency and performance of the combination different entities of an IP network like an IP service management node, a web server and a service witch. More precisely, existing solutions do not provide a coordination and scalability of a test performed for the whole IP network 100. The invention provides a solution to that problem.

### SUMMARY OF THE INVENTION

It is a broad object of a first embodiment of the present invention to provide a method for having a computer-based node for simulating requests for Internet Protocol (IP) services for a group of IP terminal in an IP network, the method comprising steps of:

reading at the computer-based node a computer readable medium stored at a memory of the computer-based node;

executing at the computer-based node instructions of the computer readable medium;

negotiating at the computer-based node a PPP connection for each IP terminal of the group of IP terminals;

establishing at the computer-based node the PPP connection for each IP terminal of the group of IP terminals;

sending from the computer-based node to a service switch a command for each IP terminal of the group of IP terminals; and

receiving at the computer-based node responses from the service switch, wherein the responses include an indicator for indicating if a command is successful.

It is another broad object of the first embodiment of the present invention to provide a computer-based node in an Internet Protocol (IP) network for simulating a group of IP terminals requesting IP based services, the computer-based node comprising:

an input/ouput (I/O) unit for receiving responses from the IP network and sending command to the IP network, wherein the responses each include an indicator for indicating if a command is successful;

a memory for storing at the computer-based node the received responses from the service switch;

a processor for reading a computer readable medium stored at a persistent memory of the computer-based node, executing instructions of the computer readable medium; and

a Point-to-Point unit for negotiating a PPP connection for each IP terminal of the group of IP terminals, establishing the PPP connection for each IP terminal of the group of IP terminals.

It is a broad object of a second embodiment of the present invention to provide a method for having a computer-based node for simulating requests for Internet Protocol (IP) services for a group of IP terminal in an IP network, the method comprising steps of:

obtaining at the computer-based node a test scenario from a memory;

generating at the computer-based node a computer medium based on the test scenario;

reading at computer-based node the computer readable medium;

executing at the computer-based node instructions of the computer readable medium;

negotiating at the computer-based node a PPP connection for each IP terminal of the group of IP terminals;

establishing at the computer-based node the PPP connection for each IP terminal of the group of IP terminals;

sending from the computer-based node to a service switch a command for each IP terminal of the group of IP terminals; and

receiving at the computer-based node responses from the service switch, wherein the responses include an indicator for indicating if a command is successful.

It is another broad object of the second embodiment of the present invention to provide a computer-based node in an Internet Protocol (IP) network for simulating a group of IP terminals requesting IP based services, the computer-based node comprising:

an input/ouput (I/O) unit for receiving responses from the IP network and sending command to the IP network, wherein the responses each include an indicator for indicating if a command is successful;

a memory for storing at the computer-based node the received responses from the service switch;

a processor for obtaining a test scenario from the memory and generating a computer medium based on the test scenario reading a computer readable medium stored at a persistent memory of the computer-based node, executing instructions of the computer readable medium; and

a Point-to-Point unit for negotiating a PPP connection for each IP terminal of the group of IP terminals, establishing the PPP connection for each IP terminal of the group of IP terminals.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 illustrates an Internet Protocol (IP) based network in which a terminal requests IP services in accordance to the prior art;

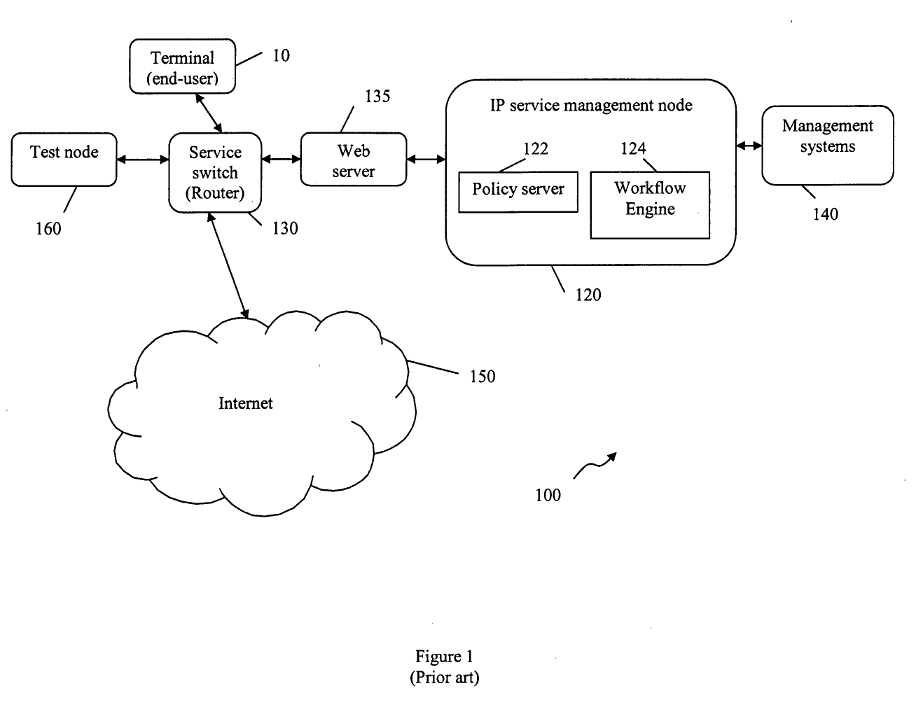

FIG. 2 illustrates an IP based network in which a terminal requests IP services in accordance to a first embodiment of the present invention;

FIG. 3 illustrates a computer-based node that performs a simulation of a plurality of PPP connections and further IP service requests for a group of IP terminals in an IP based network in accordance to a first embodiment of the invention;

FIG. 4 is a flow chart showing a method for performing a simulation of a plurality of PPP connections for a group of terminals in an IP based network in accordance to a first embodiment of the invention;

FIG. 5 illustrates an IP based network in which a terminal requests IP services in accordance to a second embodiment of the present invention;

FIG. 6 illustrates a computer-based node that performs a simulation of a plurality of PPP connections for a group of terminals in an IP based network in accordance to a second embodiment of the invention; and

FIG. 7 is a flow chart showing a method for performing a simulation of a plurality of PPP connections and further IP service requests for a group of IP terminals in an IP based network in accordance to a second embodiment of the invention.

### DETAILED DESCRIPTION OF THE PREFERRED EMBODIMENTS

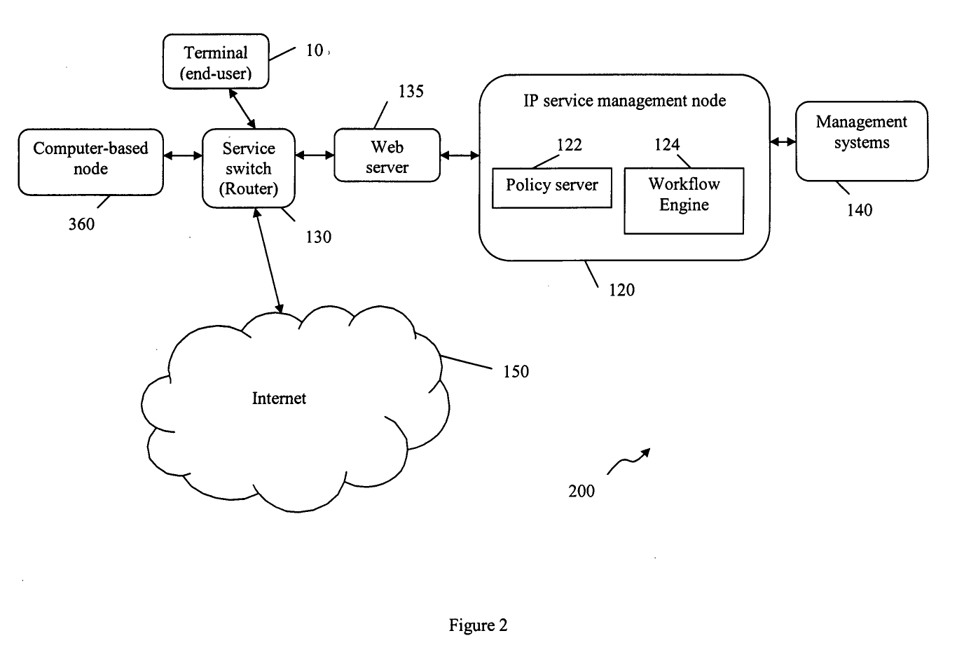

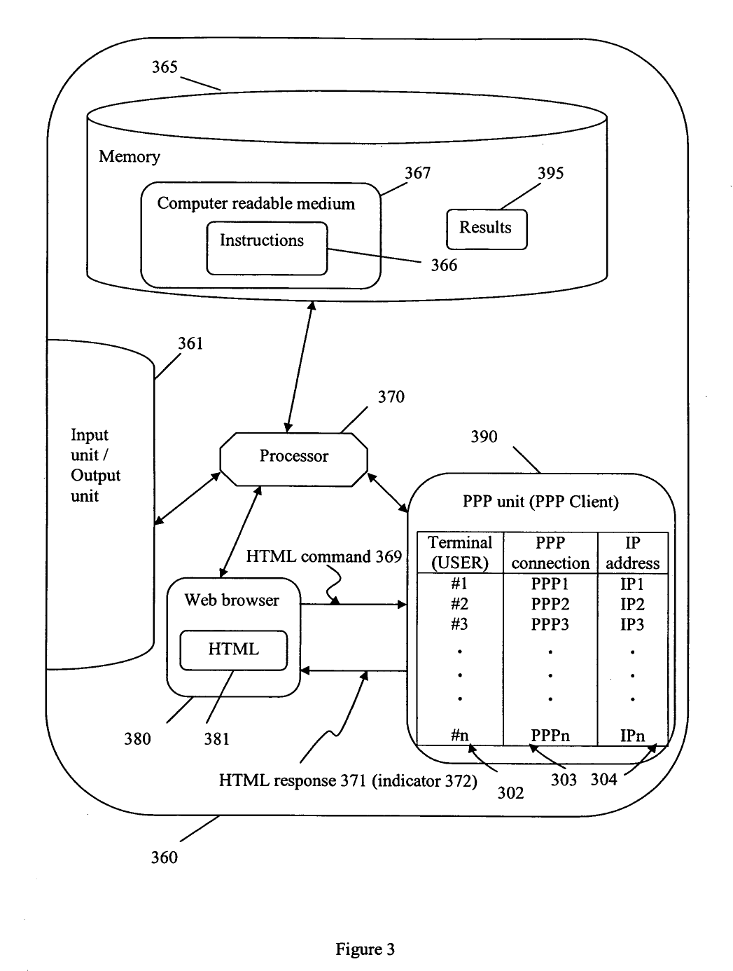

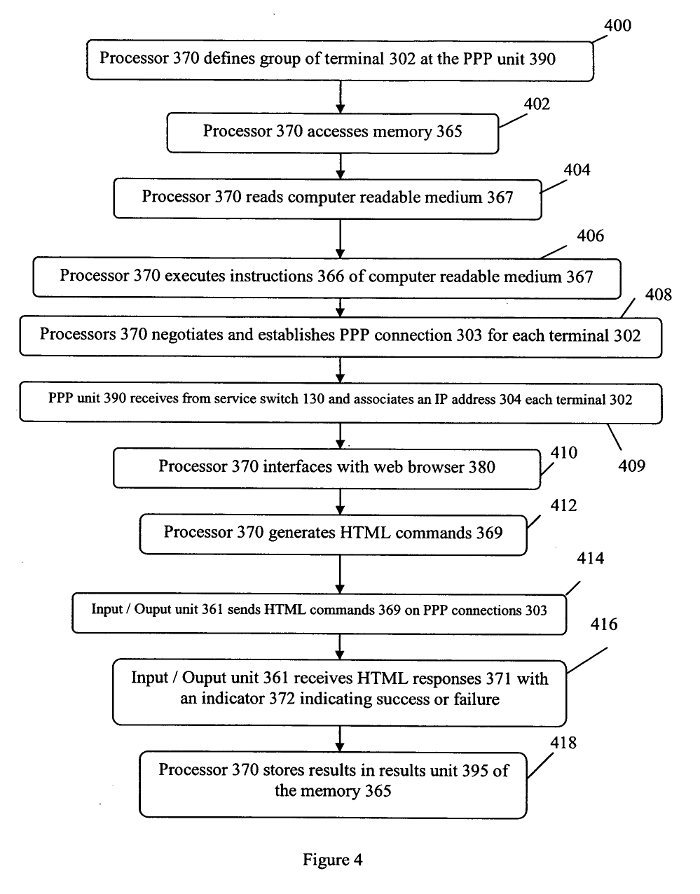

Reference is now made to FIG. 2, which illustrates an Internet Protocol (IP) based network 200 in which a terminal 10 may request IP services in accordance to a first embodiment of the present invention. Reference is also made to FIGS. 3, which illustrates a computer-based node 360 that performs a simulation of a plurality of PPP connections and further IP service requests for a group of IP terminals 302 in the IP based network 200 in accordance to the first embodiment of the invention and to FIG. 4, which is a flow chart showing a method for performing a simulation of a plurality of PPP connections and further IP service requests for a group of IP terminals 302 in the IP based network 200 in accordance to the first embodiment of the invention.

The group of IP terminals 302 is a representation of a plurality of different IP terminals that are similar to the IP terminal 10. The IP terminal 10 may be any mobile terminal or fixed terminal that allows a user to receive IP based services like High Speed Internet Access, video on demand (Multicast), video broadcast (Multicast), Voice over IP (VoIP) and teleconferencing in an IP based network such as the IP based network 200. It can be understood that the IP services are not only limited to the listed IP based services.

The IP based network 200 comprises similar network elements as previously described in the prior art. In addition to the previously described elements, the IP based network 200 comprises a computer-based node 360 for simulating the group of IP terminals 302 accessing the IP based network 200 for requesting and receiving IP services.

The computer-based node 360 comprises an input/output (I/O) unit 361 for receiving information from the network 200 and for sending information to the IP network 200, a processor 370 for operating the computer-based node 360, a memory 365 for storing information that can be accessed by the processor 370, a web browser element 380 for providing a Hypertext Markup Language (HTML) functionality 381 to the computer based node 360. The HTML language is defined in Request for Comments (RFC) 1866 Hypertext Markup Language—2.0, published by the Internet Engineering Task Force (IETF) in November 1995. The memory 365 may be any persistent memory like a Read-Only Memory (ROM), a Structured Query Language (SQL) database or a Flash memory. The computer-based node 660 further comprises a Point-to-Point (PPP) unit 390, which acts as a PPP client with the service switch 130. The computer-based node 360 can be hardware, software, or any combination thereof.

The group of IP terminals 302 is defined at the PPP unit 390 of the computer-based node 360 as a result of the execution of instructions 366 at the processor 370 (step 400). Following this, the processor 370 accesses the memory 365 (step 402) and reads the computer readable medium 367 stored in the memory 365 (step 404). For example, the computer readable medium 367 may be written, while no being limited to, in PERL, C or any language for programming that works with HTML.

At step 406, the computer-based node executes the instructions 366 of the computer readable medium 367. Following this, at step 408, the processor 370 negotiates with the service switch 130 and establishes a PPP connection 303 for each IP terminal of the group of IP terminals 302.

During the negotiation of the PPP connections 303 between the computer-based node 360 and the service switch 130, an IP address 304 is provided by the service switch 130, as defined in RFC 1661 Point-to-Point Protocol (PPP), published by the IETF in July 1994. The PPP unit 390 then associates each terminal 302 with the received IP address 304 received from the service switch 130, as shown in FIG. 3 (step 409). In particular, each IP terminal from the defined group of IP terminals 302 received a distinct IP address 304 from the service switch 130 and a PPP connection 303 is established for each IP terminal of the group of terminals 302 in the IP network 200.

In order to perform a simulation of requests for IP services made by each IP terminal of the group of IP terminals 302 and further to test the performance and efficiency of the IP network 200, a HTML command needs to be sent on an established PPP connection 303 from the computer-based node 360 to the IP service management node 120 for each IP terminal of the group of IP terminals 302. Then at step 410, the processor 370 interfaces with the web browser elements 380 and generates a HTML command 369 for each IP terminal of the group of IP terminals 302 (step 412). More precisely, the HTML command 369 is a consequence of a selection of IP based service by on of the IP terminals 302 on a web page that provided to the terminal by the web server 135 via the web browser element 380. The HTML command 369 is defined in RFC 2068 Hypertext Transfer Protocol—HTTP/1.1, published by the IETF in January 1997 and the web page access is defined in RFC 3875 The Common Gateway Interface (CGI) Version 1.1, published by the IETF in October 2004.

At step 414, the input/ouput (I/O) unit 361 sends the HTML command 369 the HTML command 369 to the service switch 130 which transfers the HTML command 369 to web server 135. The HTML command 369 is then sent from the web server 135 and ultimately to the IP service management node 120 for each IP terminal of the group of IP terminals 302. Subsequently, the IP service management node 120 retrieves a stored profile for each IP terminal of the group of IP terminals 302 and directly answers the service switch 130. The service switch 130 determines if the grant of the requested IP service was successful or unsuccessful based on a timer and a counter for obtaining the requested IP service. An indicator 372 indicating that an IP service request is successful or failure for an HTML command 369 is sent from the IP service management node 120 to the I/O unit 361 of the computer-based node 360 for each IP terminal of the group of IP terminals 302 in a distinct HTML response 371 for responding to the HTML command 369 (step 416).

It can be understood that a plurality of HTML commands 369 for different IP terminals can be sent simultaneously from the computer based node to the IP service management node 120 and that in a similar fashion a plurality of HTML responses 371 for different IP terminals can be received simultaneously at the computer based node. At step 418, processor 370 stores the results in a results database 395 of the memory 365, following the reception of the HTML responses in order to analyze the performance and efficiency of the IP network 200. Furthermore, an indicator 372 may contain the period of time required to respond to the HTML command 369.

Alternatively, a test scenario may be executed for performing a simulation of a group of IP terminals. A test scenario is be stored on a memory and can be defined as a set of parameters and conditions such as a number of IP terminals to be simulated, a simulation time limit, a type of user service level like bandwidth-on-demand functionality, IPtv, Rapidity on Demand or adjustable download data rate traffic depending on the IP based service and according to the user's service profile.

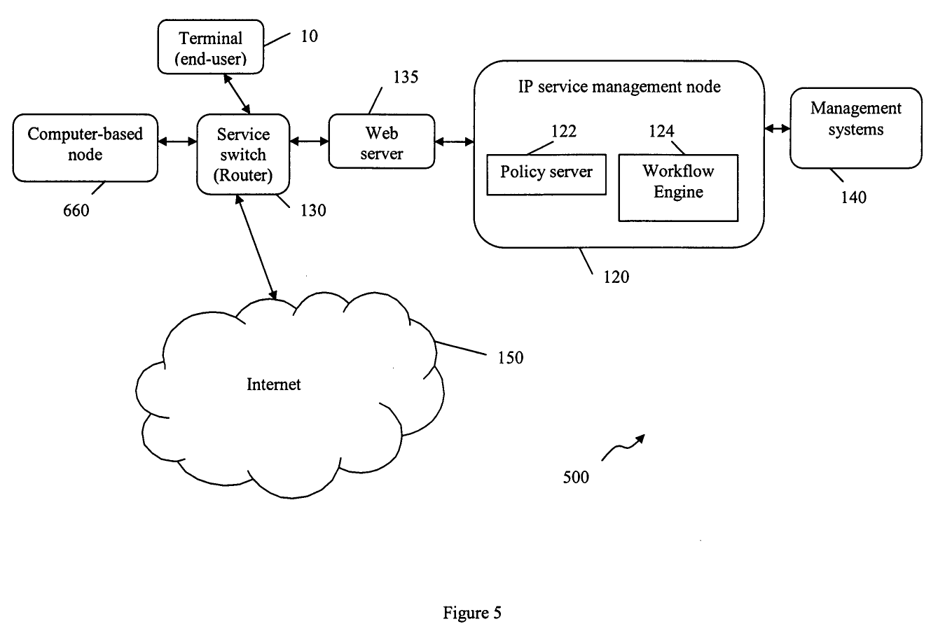

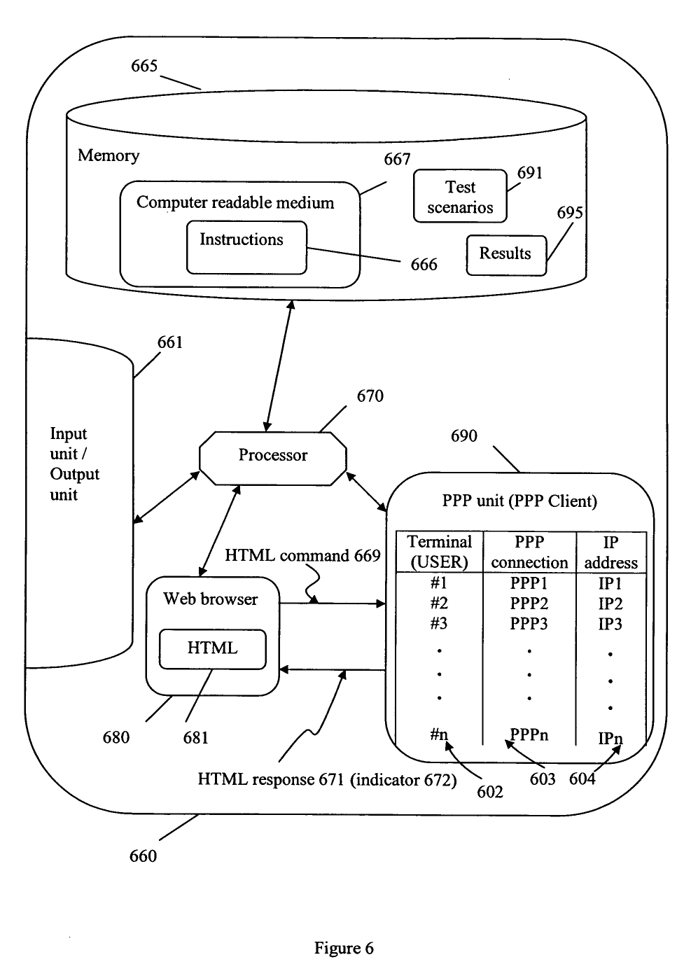

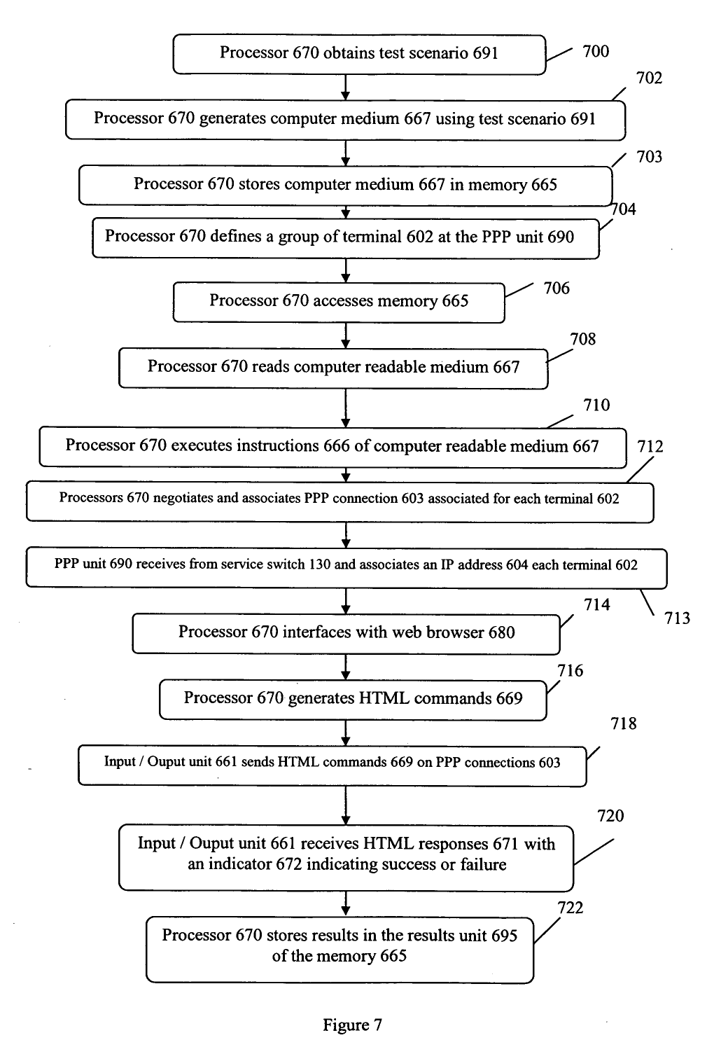

Reference is now made to FIG. 5, which illustrates an IP based network 500 in which a terminal 10 may request IP services in accordance to a second embodiment of the present invention. Reference is also made to FIGS. 6, which illustrates a computer-based node 660 that performs a simulation of a plurality of PPP connections and further IP service requests for a group of IP terminals 302 in the IP based network 500 in accordance to the second embodiment of the invention and to FIG. 7, which is a flow chart showing a method for performing a simulation of a plurality of PPP connections and further IP service requests for a group of IP terminals 602 in the IP based network 500 in accordance to the second embodiment of the invention.

The IP based network 500 comprises similar network elements as previously described in the prior art. In addition to the previously described elements, the IP based network 500 comprises a computer-based node 660 for or simulating a group of IP terminals 602 accessing the IP based network 500 for requesting and receiving IP services.

The computer-based node 660 comprises an input unit 661 for receiving information from the IP network 500, an input/output (I/O) unit 661 for sending information to the IP network 500, a processor 680 for operating the computer-based node, a memory 665 for storing information that can be accessed by the processor 680, a web browser element 681 for providing a HTML functionality 681 to the computer based node 660. The computer-based node further comprises a Point-to-Point (PPP) unit 690, which acts as a PPP client with the service switch 130.

At step 700, the processor 670 obtains a test scenario 691 from the memory 665. The processor further generates a computer readable medium 667 similar as the computer readable medium 367 (step 702). The computer readable medium 667 is stored in the memory for further access (step 703). For example, the computer readable medium 667 may be written, while no being limited to, in PERL, C or any language for programming that works with HTML.

The group of IP terminals 602 is defined at the PPP unit 690 of the computer-based node 660 as a result of the execution of instructions 666 at the processor 670 (step 704). Following this, the processor 670 accesses the memory 665 (step 706) and reads the generated computer readable medium 667 stored in the memory 365 (step 708).

The group of IP terminals 602 is a representation of a plurality of different IP terminals that are similar to the IP terminal 10. The IP terminal 10 may be any mobile terminal or fixed terminal that allows a user to receive IP based services like High Speed Internet Access, video on demand (Multicast), video broadcast (Multicast), Voice over IP (VoIP) and teleconferencing in an IP based network such as the IP based network 500. It can be understood that the IP services are not only limited to the listed IP based services.

The IP based network 500 comprises similar network elements as previously described in the prior art. In addition to the previously described elements, the IP based network 500 comprises a computer-based node 660 for simulating the group of IP terminals 302 accessing the IP based network 500 for requesting and receiving IP services.

The computer-based node 660 comprises an input unit/output unit 661 for receiving information from the network 500 and for sending information to the network 500, a processor 570 for operating the computer-based node 660, a memory 565 for storing information that can be accessed by the processor 570, a web browser element 680 for providing a HTML functionality 681 to the computer based node 660. The memory 565 may be any persistent memory like a Read-Only Memory (ROM), a Structured Query Language (SQL) database or a Flash memory. The computer-based node 660 further comprises a Point-to-Point (PPP) unit 690, which acts as a PPP client with the service switch 130. The computer-based node 660 can be hardware, software, or any combination thereof.

The group of IP terminals 602 is defined at the PPP unit 690 of the computer-based node 660 (step 704). Following this, the processor 680 accesses the memory 665 (step 706) and reads the computer readable medium 667 stored in the memory 665 (step 708). For example, the computer readable medium 767 may be written, while no being limited to, in PERL, C or any language for programming that work with HTML.

At step 710, the computer-based node executes the instructions 666 of the computer readable medium 667. Following this, at step 712, the processor 670 negotiates with the service switch 130 and establishes a PPP connection 603 for each IP terminal of the group of IP terminals 602.

During the negotiation of the PPP connections 603 between the computer-based node 660 and the service switch 130, an IP address 604 is provided by the service switch 130, as defined in RFC 1661 Point-to-Point Protocol (PPP), published by the IETF in July 1994. The PPP unit 690 then associates each terminal 602 with the received IP address 604 received from the service switch 130, as shown in FIG. 6 (step 713). In particular, each IP terminal from the defined group of IP terminals 602 received a distinct IP address 604 from the service switch 130 and a PPP connection 603 is established for each IP terminal of the group of IP terminals 602 in the IP network 500.

In order to perform a simulation of requests for IP services made by each IP terminal of the group of IP terminals 602 and further to test the performance and efficiency of the IP network 500, a HTML command needs to be sent on an established PPP connection 603 from the computer-based node 660 to the IP service management node 120 for each IP terminal of the group of IP terminals 602. Then at step 714, the processor 670 interfaces with the web browser elements 680 and generates a HTML command 669 for each IP terminal of the group of IP terminals 602 (step 716). More precisely, the HTML command 669 is a consequence of a selection of IP based service by on of the IP terminals 602 on a web page that provided to the terminal by the web server 135 via the web browser element 680.

At step 718, the I/O unit 661 sends the HTML command 669 to the service switch 120 which transfers the HTML command 669 to web server 135. The HTML command 669 is then sent from the web server 135 and ultimately to the IP service management node 120 for each IP terminal of the group of IP terminals 602. Subsequently, the IP service management node 120 retrieves a stored profile for each IP terminal of the group of IP terminals 602 and directly answers the service switch 130. The service switch 130 determines if the grant of the requested IP service was successful or unsuccessful based on a timer and a counter for obtaining the requested IP service. An indicator 672 indicating that an IP service request is successful or failure for an HTML command 669 is sent from the IP service management node 120 to the I/O unit 661 of the computer-based node 660 for each IP terminal of the group of IP terminals 602 in a distinct HTML response 671 for responding to the HTML command 669 (step 720). It can be understood that a plurality of HTML commands 669 for different IP terminals can be sent simultaneously from the computer based node to the IP service management node 120 and that in a similar fashion a plurality of HTML responses 671 for different IP terminals can be received simultaneously at the computer based node. At step 722, the processor 370 stores the results in a results database 695 of the memory 665, following the reception of the HTML responses in order to analyze the performance and efficiency of the IP network 500. Furthermore, an indicator 672 may contain the period of time required to respond to the HTML command 669.

Afterwards, the stored results 395 and 695 allow evaluating the Quality of Service (QoS) during evaluation of a performance performed simultaneously for a plurality of network elements like the service switch 130, the web server 135 and ultimately the whole IP networks 200 and 500. The present invention also renders possible a simulation for a plurality of IP terminals.

It can also be understood that some elements of the IP network 200 and 500 are not described for clarity purpose and that some illustrated network elements can be combined or used as standalone. The IP based networks 200 and 500 may be any network such as an High data that uses IP for routing packet data between IP terminals or between network elements and an IP terminal.

Although several preferred embodiments of the method and the Core Network Gateway node of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for having a computer-based node for simulating requests for Internet Protocol (IP) services for a group of IP terminal in an IP network, the method comprising steps of:
reading at the computer-based node a computer readable medium stored at a memory of the computer-based node;
executing at the computer-based node instructions of the computer readable medium;
negotiating at the computer-based node a PPP connection for each IP terminal of the group of IP terminals;
establishing at the computer-based node the PPP connection for each IP terminal of the group of IP terminals;
sending from the computer-based node to a service switch a command for each IP terminal of the group of IP terminals; and
receiving at the computer-based node responses from the service switch, wherein the responses include an indicator for indicating if a command is successful.

2. The method of claim 1, wherein the method performs a step of defining at the computer-based node a group of IP terminals prior the step of reading.

3. The method of claim 1, wherein the step of sending from the computer-based node to the service switch a command for each IP terminal of the group of IP terminals includes the steps of:
interfacing at the computer-based node a web browser;
generating at the computer-based node the command; and
sending from the computer-based node the command on the PPP connection.

4. The method of claim 1, wherein the step receiving further include the step of storing at a result database of the memory a received indicator from the service switch.

5. The method of claim 1, wherein the following step are perform prior the step of reading:
obtaining at the computer-based node a test scenario from the memory; and
generating at the computer-based node the computer medium based on the test scenario.

6. A computer-based node in an Internet Protocol (IP) network for simulating a group of IP terminals requesting IP based services, the computer-based node comprising:
an input/ouput (I/O) unit for receiving responses from the IP network and sending command to the IP network, wherein the responses each include an indicator for indicating if a command is successful;
a memory for storing at the computer-based node the received responses from the service switch;
a processor for reading a computer readable medium stored at a persistent memory of the computer-based node, executing instructions of the computer readable medium; and
a Point-to-Point unit for negotiating a PPP connection for each IP terminal of the group of IP terminals, establishing the PPP connection for each IP terminal of the group of IP terminals.

7. The computer-based node of claim 6, wherein the I/O unit further sends to a service switch on the PPP connection a command for each IP terminal of the group of IP terminals and receives responses from the service switch, wherein the responses include an indicator for indicating if a command is successful.

8. The computer based node of claim 6, wherein the processor defines the group of IP terminals prior reading the computer readable medium.

9. The computer-based node of claim 8, wherein the processor interfaces the web browser, generates the command and sends the command on the PPP connection.

10. The computer-based node of claim 6, wherein the processor stores at a result database of the memory the received indicator from the service switch.

11. The computer-based node of claim 6, wherein, the processor obtains a test scenario from the memory and generates a computer medium based on the test scenario.

12. A method for having a computer-based node for simulating requests for Internet Protocol (IP) services for a group of IP terminal in an IP network, the method comprising steps of:
obtaining at the computer-based node a test scenario from a memory;
generating at the computer-based node the computer medium based on the test scenario;
reading at the computer-based node the computer readable medium;
executing at the computer-based node instructions of the computer readable medium;
negotiating at the computer-based node a PPP connection for each IP terminal of the group of IP terminals;
establishing at the computer-based node the PPP connection for each IP terminal of the group of IP terminals;
sending from the computer-based node to a service switch a command for each IP terminal of the group of IP terminals; and
receiving at the computer-based node responses from the service switch, wherein the responses include an indicator for indicating if a command is successful.

13. The method of claim 12, wherein the method performs a step of defining at the computer-based node a group of IP terminals prior the step of reading.

14. The method of claim 12, wherein the step of sending from the computer-based node to the service switch a command for each IP terminal of the group of IP terminals includes the steps of:
interfacing at the computer-based node a web browser;
generating at the computer-based node the command; and
sending from the computer-based node the command on the PPP connection.

15. The method of claim 12, wherein the step receiving further include the step of storing at a result database of the memory a received indicator from the service switch.

16. A computer-based node in an Internet Protocol (IP) network for simulating a group of IP terminals requesting IP based services, the computer-based node comprising:
an input/ouput (I/O) unit for receiving responses from the IP network and sending command to the IP network, wherein the responses each include an indicator for indicating if a command is successful;
a memory for storing at the computer-based node the received responses from the service switch;
a processor for obtaining a test scenario from the memory and generating a computer medium based on the test scenario reading a computer readable medium stored at a persistent memory of the computer-based node, executing instructions of the computer readable medium; and
a Point-to-Point unit for negotiating a PPP connection for each IP terminal of the group of IP terminals, establishing the PPP connection for each IP terminal of the group of IP terminals.

17. The computer-based node of claim 16, wherein the I/O unit further sends to a service switch on the PPP connection a command for each IP terminal of the group of IP terminals and receives responses from the service switch, wherein the responses include an indicator for indicating if a command is successful.

18. The computer based node of claim 16, wherein the processor defines the group of IP terminals prior reading the computer readable medium.

19. The computer-based node of claim 16, wherein the processor interfaces a web browser and generates the command.

20. The computer-based node of claim 16, wherein the processor stores at a result database of the memory the received indicator from the service switch.
